(19) United States
(12) Patent Application Publication
(10) Pub. No.: US 2014/0374269 A1
(43) Pub. Date: Dec. 25, 2014

(54) WHEEL RIM FOR BICYCLE AND PRODUCING METHOD OF PRODUCING THE SAME

(71) Applicant: CARBOTEC INDUSTRIAL CO., LTD., Taichung City (TW)

(72) Inventor: MICHAEL LEE, Taichung City (TW)

(21) Appl. No.: 14/474,712

(22) Filed: Sep. 2, 2014

Related U.S. Application Data
(62) Division of application No. 13/364,818, filed on Feb. 2, 2012.

(30) Foreign Application Priority Data
May 20, 2011 (TW) 100117793

(51) Int. Cl. B60B 5/02

(52) U.S. Cl. CPC B60B 5/02; B60B 2310/204; B60B 2310/621; B60B 2310/234
USPC 205/159

(57) ABSTRACT

A wheel rim for bicycle of the present invention includes a carbon fiber main body and two strengthen layers. The strengthen layers are made of metal and are attached to two side surfaces of the main body by electroplating. As such, brake pads can rub against the wheel rim on the strengthen layers. Heat dissipation efficiency is enhanced so as to keep the wheel rim away from deformation, and the wheel rim is reinforced as well. Therefore, the wheel rim is made durable.

### BACKGROUND OF THE INVENTION

1. Field of the Invention

The present invention relates to a wheel rim for bicycle and a producing method thereof.

2. Description of the Prior Art

Bicycle is generally utilized for exercising or transporting. To minimize weight of bicycle, carbon fiber composite material is widely used in bicycle manufacturing. In addition, structure strength of bicycle is also benefited from such material choosing. Deservedly, carbon fiber composite material is also used for producing wheel rim.

However, carbon fiber wheel rim has to be used with unique brake pads avoiding abrasion caused by metal ingredient contained in the brake pads.

Additionally, carbon fiber wheel rim could be easily deformed in high temperature caused by friction between brake pads and itself. Thus, user would be anxious about unexpected deformation of the wheel rim.

To overcome the high temperature problem, carbon fiber wheel rim may be formed with apertures to increase heat dissipation efficiency. However, problems are then raised in structure strength and exterior appearance.

The present invention is, therefore, arisen to obviate or at least mitigate the above mentioned disadvantages.

### SUMMARY OF THE INVENTION

The main object of the present invention is to provide a carbon fiber wheel rim which is able to resist deformation caused be friction and high temperature.

To achieve the above and other objects, a wheel rim for bicycle of the present invention includes a circular carbon fiber main body and two strengthen layers.

The circular carbon fiber main body has a circular inner surface, a circular outer surface, and two circular side surfaces each of which connects the inner surface to the outer surface. The strengthen layers are made of metal, and are attached to the side surfaces by means of electroplating respectively.

The wheel rim can be produced by the steps including modeling, grinding, and electroplating.

Said modeling is to produce the circular carbon fiber main body of the wheel rim by heating and pressing carbon fiber and resin. The main body has the inner surface, the outer surface, and the side surfaces.

Said grinding is to grind the side surfaces, so that resin on the side surfaces of the main body is partially removed.

Said electroplating is to attach two metal layers to the surfaces grinded in the grinding step by means of electroplating, so that the strengthen layers are provided to the main body.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a first embodiment of the present invention;

FIG. 2 is a partial stereogram showing a cut off wheel rim of a first embodiment of the present invention;

FIG. 3 is a profile showing a first embodiment of the present invention;

FIG. 3A is a partial enlargement drawing of FIG. 3;

FIG. 4 is an enlarged profile showing a second embodiment of the present invention.

### DETAILED DESCRIPTION OF THE PREFERRED EMBODIMENTS

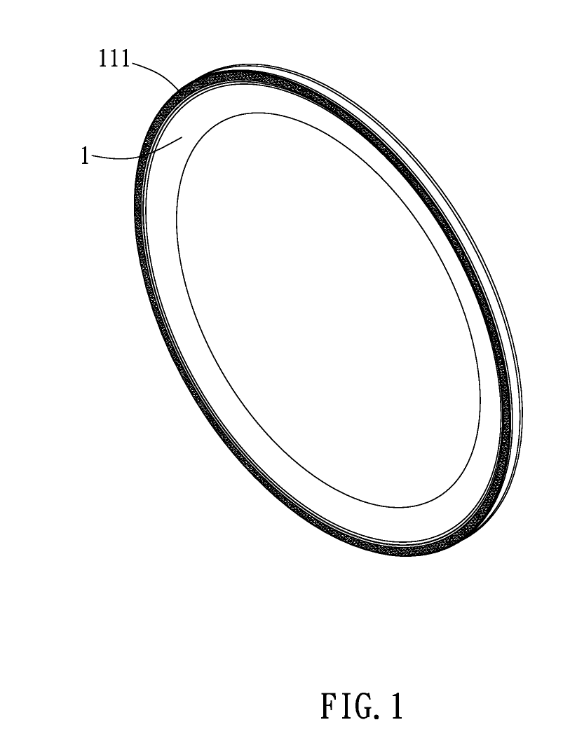

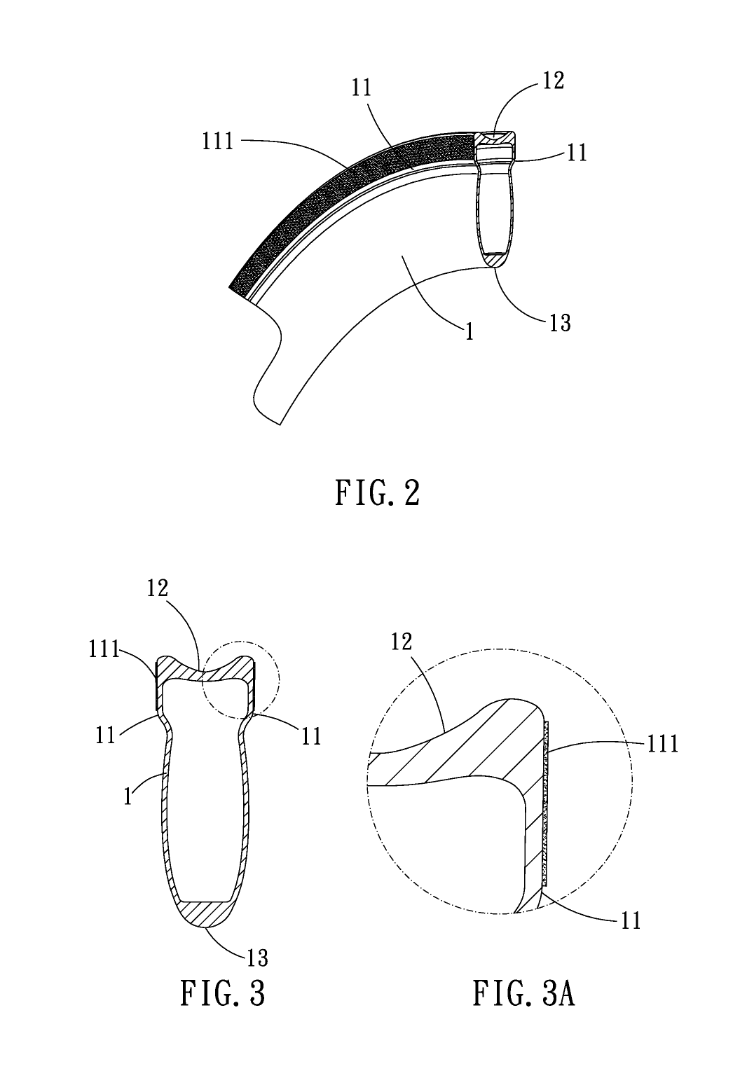

Please refer to FIG. 1 to FIG. 3 for a first embodiment of the present invention. The wheel rim for bicycle of the present embodiment includes a circular carbon fiber main body 1 and two strengthen layers 111.

The carbon fiber main body 1 has a circular inner surface 13, a circular outer surface 12, and two circular side surfaces 11 each of which connects the inner surface 13 to the outer surface 12. The side surfaces 11 are prepared for brake pads to press thereon. The carbon fiber main body 1 mentioned here is not literally means that the main body is made of only carbon fiber. To solidify carbon fiber, resin and/or other suitable material should be added in composition of the main body.

The strengthen layers 111 are made of metal. The strengthen layers 111 are attached to the side surfaces be means of electroplating respectively, as shown in FIG. 3A. Thus, brake pads may actually press and abut on the strengthen layers 111. Preferably, the strengthen layers 111 extend along the side surfaces 11, formed circularly. To obtain preferable mechanical or chemical properties, the strengthen layers 111 may be made of nickel, copper, or chromium.

To producing the wheel rim mentioned above, a producing method is here provided in the steps including modeling, grinding, and electroplating.

Said modeling is to produce the circular carbon fiber main body 1 by heating and pressing carbon fiber and resin. For modeling, suitable model and material, such as woven carbon fiber, should be prepared in advance.

Said grinding is to grind the side surfaces of the main body produced from the modeling step. After grinding, resin on the side surfaces of the main body is partially removed, so that carbon fiber is exposed outwardly. It should be noted that even the side surfaces of the main body are riddled with carbon fiber, resin is still exposed on the grinded surfaces as lines or grains.

Said electroplating is to attach two metal layers to the surfaces grinded in the grinding step by means of electroplating. The strengthen layers 111 are then provided to the main body 1. In some possible embodiments of the present invention, the whole main body may be electroplated, so that metal would attach to the ungrinded surfaces, including the inner surface and the outer surface. The additional metal may bring user a special appearance. In the present embodiment, metal can be ensured attaching to only the grinded surfaces by coating resin before or after grinding. Thus, ungrinded surfaces are covered by resin, and are nonconductive to which the metal can not attach by electroplating.

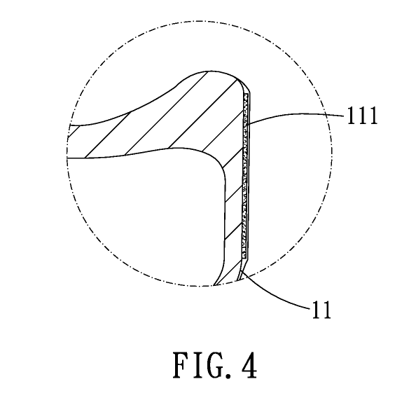

After electroplating, the side surfaces and the strengthen layers may be further coated by resin, as shown in FIG. 4. The surfaces of the wheel rim are then smoothened. Thus, an attractive appearance is prepared for the wheel rim, and disjunction of the strengthen layers is avoided.

As mentioned before, the grinded surfaces are shown up with lines or grains of resin. In electroplating step, metal can attach to surfaces where the carbon fiber is exposed. The other area of the surfaces where the resin is exposed can not be attached by metal. Therefore, the strengthen layers would be formed with porous surfaces or grooved surfaces away from the main body since that resin is nonconductive. However, the porous surface or grooved surface is not shown in figures because the pores and the grooves are small in scale and are probably filled by metal debris flaked in the electroplating step.

To facilitating electroplating, conductive layers, such as conductive paste, may be coated on the surfaces grinded in the grinding step before electroplating. It should be noted that even the grinded surfaces are coated with conductive layers, the strengthen layers are still formed with uneven surface because of conductivity difference caused by distribution of carbon fiber and resin.

To conclude, the wheel rim of the present invention is provided with strengthen layers which is attached to the main body by electroplating. Thus, the strengthen layers has porous or grooved surfaces. Heat dissipation efficiency is increased.

In addition, the strengthen layers is made of metal. Thus, heat generated by friction can be dispersed by heat conduction. Heat dissipation efficiency is then further increased.

Moreover, the wheel rim can cooperate with general brake pads which may contain metal ingredient. Limitation of composition of brake pads is relieved.

Accordingly, the wheel rim is deformation resistant, abrasion resistant, and durable.

What is claimed is:

1. A producing method of producing a wheel rim, comprising the following steps:
modeling: producing a circular carbon fiber main body of the wheel rim by heating and pressing carbon fiber and resin, the resin encapsulating the carbon fibers, the main body having a circular inner surface, a circular outer surface, and two circular side surfaces each of which connects the inner surface to the outer surface;
grinding: grinding the side surfaces, so that resin on the side surfaces of the main body is partially removed, at least part of the carbon fibers being exposed on the side surfaces after grinding;
electroplating: attaching two metal layers to the exposed carbon fibers on the surfaces grinded in the grinding step by means of electroplating, so that the strengthen layers are provided to the main body.

2. The producing method of claim 1, wherein the surfaces grinded in the grinding step are coated with conductive layers before electroplating, so that the electroplating step is facilitated.

3. The producing method of claim 1, wherein resin is coated to the side surfaces and the strengthen layers after electroplating, so that surfaces of the wheel rim are smoothened.
